(19) United States
(12) Patent Application Publication
(10) Pub. No.: US 2013/0318780 A1
(43) Pub. Date: Dec. 5, 2013

(54) METHOD FOR PRODUCING CATHODE ACTIVE MATERIAL FOR LITHIUM ION SECONDARY BATTERY

(71) Applicant: ASAHI GLASS COMPANY, LIMITED, Chiyoda-ku (JP)

(72) Inventors: Kentaro TSUNOZAKI, Chiyoda-ku (JP); Haisheng ZENG, Chiyoda-ku (JP)

(73) Assignee: ASAHI GLASS COMPANY, LIMITED, Chiyoda-ku (JP)

(21) Appl. No.: 13/963,057

(22) Filed: Aug. 9, 2013

Related U.S. Application Data
(63) Continuation of application No. PCT/JP2012/053004, filed on Feb. 9, 2012.

(30) Foreign Application Priority Data
Feb. 9, 2011 (JP) 2011-026273

(51) Int. Cl. H01M 4/50; C01D 15/02

(52) U.S. Cl. CPC H01M 4/502; C01D 15/02
USPC 29/623.5; 252/182.1; 427/126.1

(57) ABSTRACT

The present invention provides a method for producing a cathode active material for a lithium ion secondary battery excellent in the discharge capacity and the cycle characteristics and having high durability, and methods for producing a lithium ion secondary battery and a cathode for a lithium ion secondary battery.

A lithium-containing composite oxide comprising Li element and at least one transition metal element selected from the group consisting of Ni, Co and Mn (provided that the molar amount of the Li element is more than 1.2 times the total molar amount of said transition metal element) and a composition (1) {a composition having a compound (1) containing no Li element and comprising Mn element as an essential component, dissolved or dispersed in a solvent} are contacted, followed by heating to produce a cathode active material for a lithium ion secondary battery.

### TECHNICAL FIELD

The present invention relates to a method for producing a cathode active material for a lithium ion secondary battery. The present invention further relates to methods for producing a cathode for a lithium ion secondary battery and a lithium ion secondary battery using the cathode active material.

### BACKGROUND ART

Lithium ion secondary batteries are widely used for portable electronic instruments such as cell phones or notebook-size personal computers. As a cathode active material for a lithium ion secondary battery, a composite oxide of lithium with a transition metal, etc., such as LiCoO₂, LiNiO₂, LiNi_{0.8}Co_{0.2}O₂ or LiMn₂O₄, is employed.

However, in recent years, it is desired to reduce the size and weight as a lithium ion secondary battery for portable electronic instruments or vehicles, and it is desired to further improve the discharge capacity per unit mass or such characteristics that the discharge capacity does not substantially decrease after repeating the charge and discharge cycle (hereinafter sometimes referred to as cycle characteristics).

Patent Document 1 discloses a method of stirring and mixing a lithium-containing composite oxide represented by the formula LiₚNₓM_{y}O_{z}Fₐ (0.9≦p≦1.1) wherein the molar amount of the Li element is from 0.9 to 1.1 molar times the total molar amount of the transition metal element, and an aqueous solution containing zirconium, and firing the mixture in an oxygen atmosphere at 450° C. or higher to obtain a lithium-containing composite oxide having a surface layer containing zirconium oxide. Since zirconium oxide forms a covering layer using an electrochemically inactive material, if the amount of the covering material on the surface of the lithium-containing composite oxide having a surface layer containing zirconium oxide is large, the initial capacity is considered to be low.

Further, Patent Document 2 discloses that a precursor material such as LiNi_{1/3}Co_{1/3}Mn_{1/3}O₂ constituted by oxide particles containing Li and Ni, Mn and Co is contacted with a manganese nitrate solution, followed by heat treatment at 950° C. to cover the surface of the precursor material with an oxide containing Li and Ni, Mn and Co with a high Mn concentration. However, even in Patent Document 2, no sufficient discharge capacity can be obtained in the same manner as in Patent Document 1.

### PRIOR ART DOCUMENTS

### Patent Documents

Patent Document 1: WO2007/102407
Patent Document 2: Japanese Patent No. 4062169

### DISCLOSURE OF INVENTION

### Technical Problem

In order to improve the discharge capacity, it is considered to use, as a cathode active material for a lithium ion secondary battery, a lithium-containing composite oxide comprising Li element and at least one transition metal element selected from the group consisting of Ni, Co and Mn (provided that the molar amount of the Li element is more than 1.2 times the total molar amount of said transition metal element) (hereinafter sometimes referred to as “Li-rich cathode material”).

However, with the conventional Li-rich cathode material, the transition metal in the cathode material is gradually eluted upon contact with an electrolytic solution decomposed by charging at high voltage, and accordingly the crystal structure becomes unstable, and the durability will be deteriorated. Thus, the charge and discharge capacity is gradually decreased by repetitive charge and discharge, and the cycle characteristics are deteriorated. Further, in the conventional Li-rich cathode material, Li which had not been incorporated in the crystal is likely to remain as free Li on the surface of the cathode material. Free Li is considered to be present in the form of LiOH or Li₂CO₃, and if there is a large amount of free Li, the electrolytic solution is decomposed, thus deteriorating the cycle characteristics.

The present invention provides a method for producing a cathode active material for a lithium ion secondary battery excellent in the discharge capacity and the cycle characteristics and having high durability, a method for producing a cathode for a lithium ion secondary battery, and a method for producing a lithium ion secondary battery.

### Solution to Problem

The present invention provides the following.

[1] A method for producing a cathode active material for a lithium ion secondary battery, which comprises contacting the following composition (1) with a lithium-containing composite oxide comprising Li element and at least one transition metal element selected from the group consisting of Ni, Co and Mn (provided that the molar amount of the Li element is more than 1.2 times the total molar amount of said transition metal element), followed by heating:

composition (1): a composition having a compound (1) containing no Li element and comprising Mn element as an essential component, dissolved or dispersed in a solvent.

[2] The method for producing a cathode active material for a lithium ion secondary battery according to the above [1], wherein the composition (1) further contains Ni element and/or Zr element.
[3] The method for producing a cathode active material for a lithium ion secondary battery according to the above [1] or [2], wherein the heating is carried out at from 350 to 800° C.
[4] The method for producing a cathode active material for a lithium ion secondary battery according to any one of the above [1] to [3], wherein the total amount of the metal element contained in the compound (1) is within a range of from 0.002 to 0.05% by molar ratio to the total amount of the transition metal element contained in the lithium-containing composite oxide.
[5] The production method according to any one of the above [1] to [4], wherein the proportion of the following Mn composite oxide contained in the cathode active material is such an amount, as the metal element amount in the Mn composite oxide, of from 0.001 to 0.10 molar times the molar amount of the transition metal element in the lithium-containing composite oxide:

Mn composite oxide: a composite oxide comprising Mn as an essential component, formed by reaction of the lithium-containing composite oxide and the composition (1).

[6] The method for producing a cathode active material for a lithium ion secondary battery according to any one of the above [1] to [5], wherein the solvent in the composition (1) is water.
[7] The method for producing a cathode active material for a lithium ion secondary battery according to any one of the above [1] to [6], wherein pH of the composition (1) is within a range of from 3 to 12.
[8] The method for producing a cathode active material for a lithium ion secondary battery according to any one of the above [1] to [7], wherein said contacting of the composition (1) with the lithium-containing composite oxide is carried out by adding the composition (1) to the lithium-containing composite oxide under agitation and mixing the composition (1) and the lithium-containing composite oxide.
[9] The method for producing a cathode active material for a lithium ion secondary battery according to any one of the above [1] to [8], wherein said contacting of the composition (1) with the lithium-containing composite oxide is carried out by spraying the composition (1) to the lithium-containing composite oxide by a spray coating method.
[10] The method for producing a cathode active material for a lithium ion secondary battery according to any one of the above [1] to [9], wherein the lithium-containing composite oxide is a compound represented by the following formula (3):

Li(LiₓMn_{y}Me_{z})OₚF_{q} (3)

wherein Me is at least one element selected from the group consisting of Co, Ni, Cr, Fe, Al, Ti, Zr, Mo, Nb, V and Mg, 0.09<x<0.3, y>0, z>0, 0.4≦y/(y+z)≦0.8, x+y+z=1, 1.2<(1+x)/(y+z), 1.9<p<2.1, and 0≦q≦0.1.
[11] The method for producing a cathode active material for a lithium ion secondary battery according to the above [10], wherein Me is Co and Ni.
[12] A method for producing a cathode for a lithium ion secondary battery, which comprises producing a cathode active material for a lithium ion secondary battery by the production method as defined in any one of the above [1] to [11], and forming a cathode active material layer containing the cathode active material for a lithium ion secondary battery, an electrically conductive material and a binder on a cathode current collector.
[13] A method for producing a lithium ion secondary battery, which comprises producing a cathode for a lithium ion secondary battery by the production method as defined in the above [12], and constituting a lithium ion secondary battery using the cathode, an anode and a non-aqueous electrolyte.

### Advantageous Effects of Invention

According to the production method of the present invention, it is possible to obtain a cathode active material for a lithium ion secondary battery which has a stable structure and the surface of which is covered with an electrochemically active Mn composite compound.

With a cathode for a lithium ion secondary battery using the cathode active material obtained by the production method of the present invention, since the cathode active material has a covering film of an electrochemically active Mn composite oxide on its surface, a decrease in the initial capacity of a lithium ion secondary battery can be suppressed, the cycle characteristics are improved, and high durability can be realized.

### BRIEF DESCRIPTION OF DRAWINGS

FIG. 1 is a view illustrating Examples of a process for producing a cathode active material for a lithium ion secondary battery of the present invention, and is a graph illustrating discharge curves obtained by measuring the voltage and the electrical quantity of lithium batteries using cathode active materials in Examples 1 and 12 and Comparative Example 2.

### DESCRIPTION OF EMBODIMENTS

Now, the present invention will be described in detail.

### <Method for Producing Cathode Active Material>

The method for producing a cathode active material of the present invention comprises contacting the following composition (1) with a lithium-containing composite oxide comprising Li element and at least one transition metal element selected from the group consisting of Ni, Co and Mn (provided that the molar amount of the Li element is more than 1.2 times the total molar amount of said transition metal element), followed by heating:

composition (1): a composition having a compound (1) containing no Li element and comprising Mn element as an essential component, dissolved or dispersed in a solvent.

### (Lithium-Containing Composite Oxide)

The molar amount of the Li element in the lithium-containing composite oxide in the present invention is more than 1.2 times the total molar amount of the transition metal element, that is, (molar amount of Li element/total molar amount of transition metal element)>1.2. In the present invention, when the molar amount of Li is more than 1.2 times the total molar amount of the transition metal element, the discharge capacity per unit mass can be improved. Thus, in a lithium ion secondary battery comprising a cathode using the cathode active material of the present invention, the discharge capacity per unit mass after activation can be improved.

The proportion of Li to the total molar amount of the transition metal element is preferably from 1.25 to 1.75 molar times, more preferably from 1.25 to 1.65 molar times, in order to further increase the discharge capacity per unit mass of a lithium ion secondary battery. Within such a proportion, the discharge capacity per unit mass of a lithium ion secondary battery may further be increased.

As the transition metal element in the lithium-containing composite oxide, it may contain at least one member selected from the group consisting of Ni, Co and Mn, it more preferably contains Mn element as an essential component, and it particularly preferably contains all the elements Ni, Co and Mn. It may contain, as the transition metal element, metal elements other than Ni, Co, Mn and Li (hereinafter referred to as other metal elements). Such other metal elements may, for example, be Cr, Fe, Al, Ti, Zr, Mo, Nb, V and Mg. The proportion of other metal elements is preferably from 0.001 to 0.50 mol, more preferably from 0.005 to 0.05 mol in the total amount (1 mol) of the transition metal element.

The lithium-containing composite oxide is preferably a compound represented by the following formula (3). The compound represented by the following formula (3) is represented as a compositional formula before charge/discharge and a treatment such as activation are carried out. Here, activation means to remove lithium oxide (Li₂O) or lithium and lithium oxide from the lithium-containing composite oxide. The activation method may be an electrochemical activation method of charging at a voltage higher than 4.4V or 4.6 V (represented as a difference in potential with the oxidation-reduction potential of Li⁺/Li). Further, it may also be a chemical activation method of carrying out a chemical reaction using an acid such as sulfuric acid, hydrochloric acid or nitric acid.

Li(LiₓMn_{y}Me_{z})OₚF_{q} (3)

In the formula (3), Me is at least one element selected from the group consisting of Co, Ni, Cr, Fe, Al, Ti, Zr, Mo, Nb, V and Mg.

In the formula (3), 0.09<x<0.3, y>0, z>0, 0.4≦y/(y+z)≦0.8, x+y+z=1, 1.2<(1+x)/(y+z), 1.9<p<2.1 and 0≦q≦0.1. Me is preferably an element selected from the group consisting of Co, Ni and Cr, more preferably Co and/or Ni, particularly preferably Co and Ni. In the formula (3), it is preferred that 0.1<x<0.25, it is more preferred that 0.11<x<0.22, and it is preferred that 0.5≦y/(y+z)≦0.8, it is more preferred that 0.55≦y/(y+z)≦0.75. In a case where Me is Co and Ni, the molar ratio of Co/Ni is preferably from 0 to 1, more preferably from 0 to 0.5.

The lithium-containing composite oxide is preferably

Li(Li_{0.13}Ni_{0.26}Co_{0.09} Mn_{0.52})O₂, Li(Li_{0.13}Ni_{0.22}Co_{0.0.9}Mn_{0.56})O₂, Li(Li_{0.13}Ni_{0.17}Co_{0.17}Mn_{0.53})O₂, Li(Li_{0.15}Ni_{0.17}Co_{0.13}Mn_{0.55})O₂, Li(Li_{0.16}Ni_{0.17}Co_{0.08}Mn_{0.59})O₂, Li(Li_{0.17}Ni_{0.17}Co_{0.17}Mn_{0.49})O₂, Li(Li_{0.17}Ni_{0.21}Co_{0.08}Mn_{0.54})O₂, Li(Li_{0.17}Ni_{0.14}Co_{0.14}Mn_{0.55})O₂, Li(Li_{0.18}Ni_{0.12}Co_{0.12}Mn_{0.58})O₂, Li(Li_{0.18}Ni_{0.16}Co_{0.12}Mn_{0.54})O₂, Li(Li_{0.20}Ni_{0.12}Co_{0.08} Mn_{0.60})O₂, Li(Li_{0.20}Ni_{0.16}Co_{0.08}Mn_{0.56})O₂, Li(Li_{0.20}Ni_{0.13}Co_{0.13}Mn_{0.54})O₂, Li(Li_{0.22}Ni_{0.12}Co_{0.12}Mn_{0.54})O₂ or Li(Li_{0.23}Ni_{0.12}Co_{0.08}Mn_{0.57})O₂. Further, the lithium-containing composite oxide is particularly preferably Li(Li_{0.16}Ni_{0.17}Co_{0.08}Mn_{0.59})O₂, Li(Li_{0.17}Ni_{0.17}Co_{0.17}Mn_{0.49})O₂, Li(Li_{0.17}Ni_{0.21}Co_{0.08}Mn_{0.54})O₂, Li(Li_{0.17}Ni_{0.14}Co_{0.14}Mn_{0.55})O₂, Li(Li_{0.18}Ni_{0.12}Co_{0.12}Mn_{0.58})O₂, Li(Li_{0.18}Ni_{0.16}Co_{0.12}Mn_{0.54})O₂, Li(Li_{0.20}Ni_{0.12}Co_{0.08}Mn_{0.60})O₂ or Li(Li_{0.20}Ni_{0.16}Co_{0.08}Mn_{0.56})O₂, Li(Li_{0.20}Ni_{0.13}Co_{0.13}Mn_{0.54})O₂.

In a case where the lithium-containing composite oxide in the present invention is represented by the formula (3), (1+x)/(y+z) representing the proportion of the Li element to the total molar amount of the transition metal element is 1.2<(1+x)/(y+z), preferably 1.25≦(1+x)/(y+z)≦1.75, more preferably 1.25≦(1+x)/(y+z)≦1.65. When the proportion is within such a range, the discharge capacity per unit mass can be increased.

The lithium-containing composite oxide is preferably in the form of particles, and the average particle size D50 is preferably from 3 to 30 μm, more preferably from 4 to 25 μm, particularly preferably from 5 to 20 μm. In the present invention, the average particle size (D50) means a volume-based accumulative 50% size which is a particle size at a point of 50% on an accumulative curve when the accumulative curve is drawn by obtaining the particle size distribution on the volume basis and taking the whole to be 100%. The particle size distribution is obtained from the frequency distribution and accumulative volume distribution curve measured by means of a laser scattering particle size distribution measuring apparatus. The measurement of particle sizes is carried out by sufficiently dispersing the powder in an aqueous medium by e.g. an ultrasonic treatment and measuring the particle size distribution (for example, by means of a laser diffraction/scattering type particle size distribution measuring apparatus Partica LA-950VII, manufactured by HORIBA, Ltd.).

The specific surface area of the lithium-containing composite oxide is preferably from 0.3 to 10 m²/g, particularly preferably from 0.5 to 5 m²/g. When the specific surface area is from 0.3 to 10 m²/g, it is possible to form a dense cathode layer having a high capacity.

The lithium-containing composite oxide in the present invention is preferably one taking a layered rock salt type crystal structure (space group R-3m). Further, the lithium-containing composite oxide in the present invention has a high ratio of the Li element to the transition metal element, whereby in the XRD (X-ray diffraction) measurement, a peak is observed within a range of θ=20 to 25° like layered Li₂MnO₃.

A method for producing the lithium-containing composite oxide may, for example, be a method wherein a lithium compound and a precursor for a lithium-containing composite oxide obtained by a coprecipitation method, are mixed and fired, a hydrothermal synthesis method, a sol-gel method, a dry blending method or an ion exchange method. Here, preferred is a method wherein a lithium compound and a precursor for a lithium-containing composite oxide obtained by a coprecipitation method (a coprecipitated composition) are mixed and fired, since the discharge capacity will be improved when the transition metal element is uniformly contained in the lithium-containing composite oxide.

### (Composition (1))

The composition (1) in the present invention is a solution or dispersion in which a compound (1) comprising at least one metal element, containing no Li element and containing M element, is dissolved or dispersed in a solvent. The composition (1) in the present invention is contacted with the above-described lithium-containing composite oxide, followed by heating. As a result, on the surface of the lithium-containing composite oxide, the compound (1) containing in the composition (1) and the lithium-containing composite metal compound are reacted, whereby a cathode active material having a covering film formed on its surface is obtained. It is the Mn composite oxide that forms the covering film on the surface, and an electrochemically active Mn composite oxide is preferred.

The compound (1) may be an acid salt or a complex containing manganese. For example, manganese nitrate, manganese sulfate, manganese chloride, manganese acetate, manganese citrate, manganese maleate, manganese formate, manganese lactate or manganese oxalate.

The compound (1) is preferably an organic salt or an organic complex, which is likely to be decomposed by heat and which is highly soluble in a solvent, and is particularly preferably manganese acetate, manganese citrate, manganese maleate or manganese oxalate.

In a case where the composition (1) is a dispersion, the compound (1) in the dispersion is preferably manganese-containing particles of e.g. manganese carbonate, manganese hydroxide or manganese oxide.

The manganese-containing particles may be a composite carbonate, a composite hydroxide or a composite oxide containing a metal element other than Li and Mn. The metal element other than Li and Mn may be at least one metal element selected from the group consisting of Zr, Ti, Al, Sn, Mg, Ba, Pb, Bi, Ta, Zn, Y, La, Sr, Ce, In, Ni and Co. Particularly preferred is Zr, Ti, Al, Ni or Co, in view of excellent cycle characteristics and rate characteristics.

In a case where the manganese-containing particles contain a metal element other than Li and Mn, the proportion of the Mn element in the manganese-containing particles is preferably from 25 to 99 mol %, more preferably from 33 to 95 mol %, particularly preferably from 50 to 90 mol % to the total amount of all the metal elements in the manganese-containing particles. The average particle size of the compound (1) contained in the dispersion is preferably from 1 to 100 nm, more preferably from 2 to 50 nm, particularly preferably from 3 to 30 nm. The average particle size of the compound (1) contained in the dispersion is the average particle size (D50) as measured by a dynamic light scattering method.

The composition (1) in the present invention may contain a compound containing no Li and Mn, and containing a metal element other than Li and Mn (hereinafter sometimes referred to as compound (2)).

The metal element other than Li and Mn may be at least one metal element selected from the group consisting of Zr, Ti, Al, Sn, Mg, Ba, Pb, Bi, Ta, Zn, Y, La, Sr, Ce, In, Ni and Co. Particularly, preferred is Zr, Ti, Al, Ni or Co in view of excellent cycle characteristics and rate characteristics, and most preferred is Zr and/or Ni.

The compound containing Ni element may be nickel acetate, nickel citrate, nickel maleate, nickel formate, nickel lactate, nickel oxalate, hexaamminenickel, nickel carbonate, nickel hydroxide or nickel oxide.

The compound containing Zr may be ammonium zirconium carbonate, an ammonium zirconium halide, zirconium acetate, zirconium hydroxide or zirconium oxide.

In a case where the composition (1) contains the compound (1) and the compound (2), the proportion of the Mn element is preferably from 25 to 99 mol %, more preferably from 33 to 95 mol %, particularly preferably from 50 to 90 mol % to the total amount of all the metal elements.

The Mn composite oxide which may be formed by contacting the lithium-containing composite oxide with the composition (1), followed by heating, is an oxide which is capable of absorbing and desorbing Li and developing an electric capacity. The electrochemically active Mn composite oxide may be neither an oxide containing no Li or an oxide containing Li. An oxide containing Li may be formed by reaction of Mn contained in the composition (1) with free Li on the surface of the lithium-containing composite oxide or Li in the lithium-containing composite oxide.

On the other hand, in a case where the production method of the present invention is carried out by using a lithium-containing composite oxide which is not a Li-rich cathode material, Li in the lithium-containing composite oxide may be absorbed by the covering material, thus leading to a decrease in the initial capacity and the deterioration of the cycle characteristics.

In the present invention, by using a Li-rich cathode material as the lithium-containing composite oxide, there is such an advantage that a decrease in the initial capacity and the deterioration of the cycle characteristics hardly occur.

The Mn composite oxide may, for example, be manganese spinel having a structural crystal of space group Fd3-m.

The cathode active material obtained by the production method of the present invention has a covering film derived from the compound (1) formed on the surface of the lithium-containing composite oxide. The covering film has a stable structure and may be constituted by a Mn composite oxide, whereby elution of the transition metal element particularly Mn element in the Li-rich cathode material is suppressed. Thus, when such a material is applied to a cathode for a lithium ion secondary battery, a decrease in the capacity can be suppressed even when charge and discharge cycles are carried out at high voltage (particularly 4.5 V or higher), and excellent cycle characteristics will be obtained. Further, since the Mn composite oxide develops a capacity at the time of charge and discharge of a battery, a decrease in the initial capacity by covering can be suppressed, and a high discharge capacity and cycle characteristics will be obtained.

The cathode active material in the present invention is preferably in the form of particles having the surface of the lithium-containing composite oxide covered with an electrochemically active Mn composite oxide. The particles are particles in such a state that the oxide containing Mn element is contained in a larger amount at the surface than the center of the lithium-containing composite oxide. The surface of the lithium-containing composite oxide being covered with the Mn composite oxide in the cathode active material may be confirmed, for example, by cutting a particle of the cathode active material, then polishing the cross section, followed by elemental mapping by an X-ray microanalyzer analysis (EPMA). By such an evaluation method, it is possible to confirm that the Mn composite oxide is present in a larger amount in a range of 100 nm from the surface than the center of the lithium-containing composite oxide (here, the center means a portion not in contact with the surface of the lithium-containing composite oxide, preferably a portion where the average distance from the surface is the largest).

The proportion of the Mn composite oxide in the surface of the cathode active material is calculated based on the amount of the lithium-containing composite particles and the compound (1) charged.

The proportion of the Mn composite oxide contained in the cathode active material particles is preferably such that the metal element amount in the Mn composite oxide is from 0.001 to 0.10 molar times, more preferably from 0.002 to 0.05 molar times, particularly preferably from 0.004 to 0.04 molar times, the molar amount of the transition metal element in the lithium-containing composite oxide.

In the cathode active material of the present invention, the shape of the Mn composite oxide covering the surface of the lithium-containing composite oxide can be confirmed by an electron microscope such as a SEM (scanning electron microscope) or a TEM (transmission electron microscope). The shape of the Mn composite oxide may be a particle-form, a film-form, an agglomerated form or the like. In a case where the Mn composite oxide is in a particle-form, the average particle size of the Mn composite oxide is preferably from 1 to 100 nm, more preferably from 2 to 50 nm, particularly preferably from 3 to 30 nm. The average particle size of the Mn composite oxide is an average of particle sizes of particles covering the surface of the lithium-containing composite oxide, as observed by an electron microscope such as SEM or TEM.

The Mn composite oxide is preferably present in such a state that it covers at least part of the surface of the lithium-containing composite oxide.

The cathode active material in the present invention employs a lithium-containing composite oxide with a high lithium proportion, whereby the discharge capacity is high. Further, with the cathode active material of the present invention, a decrease in the initial capacity in the lithium ion secondary battery will not occur even when the covering amount is increased to suppress an eluate from the lithium-containing composite oxide, since the cathode active material of the present invention comprises particles having the surface of the lithium-containing composite oxide covered with the Mn composite oxide. Further, the decrease in the capacity is suppressed even when charge and discharge cycles are carried out at high voltage (particularly at 4.5 V or higher), and excellent cycle characteristics and high durability are obtained.

In the method for producing a cathode active material of the present invention, the above lithium-containing composite oxide and the composition (1) are contacted and heated.

The solvent to be used for the composition (1) is preferably a solvent containing water from the viewpoint of the reactivity or the stability of the compound (1) itself or the compound (1) in the form of particles, more preferably a mixed solvent of water and a water-soluble alcohol and/or polyol, particularly preferably water. The water-soluble alcohol may, for example, be methanol, ethanol, 1-propanol or 2-propanol. The polyol may, for example, be ethylene glycol, propylene glycol, diethylene glycol, dipropylene glycol, polyethylene glycol, butanediol or glycerin. The total content of the water-soluble alcohol and the polyol contained in the solvent is preferably from 0 to 90 mass %, more preferably from 0 to 30 mass %, based on the total amount of the respective solvents (the entire amount of solvent). It is particularly preferred that the solvent is solely water, since water is excellent from the viewpoint of the safety, environmental aspect, handling efficiency and cost.

Further, the composition (1) may contain a pH-adjusting agent. The pH-adjusting agent is preferably one which volatilizes or decomposes when heated. Specifically, an organic acid such as acetic acid, citric acid, lactic acid, formic acid, maleic acid or oxalic acid, or ammonia is preferred.

The pH of the composition (1) is preferably from 3 to 12, more preferably from 3.5 to 12, particularly preferably from 4 to 10. When the pH is within such a range, elution of Li element from the lithium-containing composite oxide is less when the composition (1) and the lithium-containing composite oxide are contacted, and impurities such as a pH-adjusting agent, etc. are less, whereby good battery characteristics can easily be obtainable.

Preparation of the composition (1) is preferably carried out by heating as the case requires. The heating temperature is preferably from 40° C. to 80° C., particularly preferably from 50° C. to 70° C. By the heating, dissolution of the metal-containing compound in the solvent readily proceeds, whereby the dissolution can be carried out stably.

The concentration of the compound (1) contained in the composition (1) is preferably high from such a viewpoint that it is necessary to remove the solvent by heating in the subsequent step. However, if the concentration is too high, the viscosity becomes high, whereby uniform mixing property of the composition (1) with other element sources to form the cathode active material tends to deteriorate. The concentration of the compound (1) is preferably from 0.5 to 24 mass %, particularly preferably from 2 to 16 mass %, as calculated as the metal element.

As the method of contacting the composition (1) with the lithium-containing composite oxide, for example, a spray coating method or a dipping method may be applied, and a method of spraying the composition (1) to the lithium-containing composite oxide by a spray coating method, is particularly preferred. In the dipping method, it is necessary to remove the solvent by filtration or evaporation after the contact, whereby the process becomes cumbersome. In the case of the spray coating method, the process is simple, and it is possible to uniformly deposit the electrochemically active Mn composite oxide on the surface of the lithium-containing composite oxide.

The total amount of the composition (1) to be contacted with the lithium-containing composite oxide is preferably from 1 to 50 mass %, more preferably from 2 to 40 mass %, particularly preferably from 3 to 30 mass %, to the lithium-containing composite oxide. When the amount of the composition (1) is within such a range, it is easy to uniformly deposit the composition (1) on the surface of the lithium-containing composite oxide, and at the time of spray coating the composition (1) to the lithium-containing composite oxide, the lithium-containing composite oxide will not be agglomerated, and agitation can be facilitated.

Further, in the method of the present invention, it is preferred to add the composition (1) to the lithium-containing composite oxide under agitation and mix the composition (1) and the lithium-containing composite oxide, to contact the composition (1) with the lithium-containing composite oxide. As an agitating apparatus, a drum mixer or a solid air low shearing force agitator may be employed. By contacting the composition (1) with the lithium-containing composite oxide under agitation and mixing, it is possible to obtain a cathode active material having surface of the lithium-containing composite oxide covered with the electrochemically active Mn composite oxide.

In the present invention, the compound (2) may not necessarily be contained in the composition (1), and a composition (2) having the compound (2) dissolved or dispersed in a solvent may be used.

In the composition (2), the concentration of the compound (2) is preferably from 0.5 to 24 mass %, particularly preferably from 2 to 16 mass %, as calculated as the metal element.

The total amount of the composition (2) contacted with the lithium-containing composite oxide is preferably from 1 to 50 mass %, more preferably from 2 to 40 mass %, particularly preferably from 3 to 30 mass % to the lithium-containing composite oxide.

In the method for producing a cathode active material for a lithium ion secondary battery of the present invention, the lithium-containing composite oxide and the composition (1) are contacted, followed by heating. By heating, the desired cathode active material is obtained, and at the same time, volatile impurities such as water and organic components can be removed.

The heating is carried out preferably in an oxygen-containing atmosphere. The heating temperature is preferably from 350 to 800° C., more preferably from 350 to 650° C., particularly preferably from 350 to 500° C. When the heating temperature is at least 350° C., there is such an advantage that the compound (1) tends to be highly reactive. Further, since volatile impurities such as remaining water tend to be reduced, the cycle characteristics will be improved. Further, when the heating temperature is within the above range, it is possible to prevent the Mn composite oxide which may form by the reaction of the lithium-containing composite oxide and the compound (1) from being further reacted with the lithium or the lithium-containing composite oxide, the surface of the lithium-containing composite oxide will efficiently be covered with the Mn composite oxide, and the cycle characteristics will be improved. If the heating temperature is too high, the surface area of the lithium-containing composite oxide tends to be reduced and the initial capacity tends to be low, and accordingly the upper limit of the heating temperature is preferably 800° C.

The heating time is preferably from 0.1 to 24 hours, more preferably from 0.5 to 18 hours, particularly preferably from 1 to 12 hours. When the heating temperature is within the above range, the surface of the lithium-containing composite oxide will efficiently be covered with the Mn composite oxide.

The pressure at the time of heating is not particularly limited, and is preferably normal pressure or elevated pressure, particularly preferably normal pressure.

### <Method for Producing Cathode for Lithium Ion Secondary Battery>

The cathode for a lithium ion secondary battery of the present invention comprises a cathode active material layer containing the above cathode active material, an electrically conductive material and a binder formed on a cathode current collector. The cathode for a lithium ion secondary battery can be produced, for example, in such a manner that the cathode active material of the present invention, an electrically conductive material and a binder are dissolved in a solvent, dispersed in a dispersing medium or kneaded with a solvent, to prepare a slurry or kneaded product, and the prepared slurry or kneaded product is supported on a cathode current collector by e.g. coating. As the cathode current collector, a metal foil such as an aluminum foil or a stainless steel foil may be used.

The electrically conductive material may, for example, be a carbon black such as acetylene black, graphite or ketjen black.

The binder may, for example, be a fluorine resin such as polyvinylidene fluoride or polytetrafluoroethylene, a polyolefin such as polyethylene or polypropylene, an unsaturated bond-containing polymer or copolymer such as styrene/butadiene rubber, isoprene rubber or butadiene rubber, or an acrylic acid type polymer or copolymer such as an acrylic acid copolymer or a methacrylic acid copolymer.

### <Method for Producing Lithium Ion Secondary Battery>

The lithium ion secondary battery of the present invention comprises the cathode, an anode and a non-aqueous electrolyte, wherein the cathode before activation is the above cathode for a lithium ion secondary battery.

The anode comprises an anode current collector and an anode active material layer containing an anode active material, formed thereon. It can be produced, for example, in such a manner that an anode active material and an organic solvent are kneaded to prepare a slurry, and the prepared slurry is applied to an anode current collector, followed by drying and pressing.

As the anode current collector, a metal foil such as a nickel foil or cupper foil may, for example, be used.

The anode active material may be any material so long as it is capable of absorbing and desorbing lithium ions. For example, it is possible to employ a lithium metal, a lithium alloy, a lithium compound, a carbon material, an oxide composed mainly of a metal in Group 14 or 15 of the periodic table, a carbon compound, a silicon carbide compound, a silicon oxide compound, titanium sulfide, a boron carbide compound, etc.

As the lithium alloy or lithium compound, it is possible to employ a lithium alloy or lithium compound constituted by lithium and a metal which is capable of forming an alloy or compound with lithium.

As the carbon material, it is possible to use, for example, non-graphitizable carbon, artificial graphite, natural graphite, thermally decomposed carbon, cokes such as pitch coke, needle coke, petroleum coke, etc., graphites, glassy carbons, an organic polymer compound fired product obtained by firing and carbonizing a phenol resin, furan resin, etc. at a suitable temperature, carbon fibers, activated carbon, carbon blacks, etc.

The metal in Group 14 of the periodic table may, for example, be silicon or tin, and most preferred is silicon. Further, as a material which is capable of absorbing and desorbing lithium ions at a relatively low potential, it is possible to use, for example, an oxide such as iron oxide, ruthenium oxide, molybdenum oxide, tungsten oxide, titanium oxide, tin oxide, etc. or other nitrides.

As the non-aqueous electrolyte, it is preferred to employ a non-aqueous electrolytic solution having an electrolyte salt dissolved in a non-aqueous solvent.

As the non-aqueous electrolytic solution, it is possible to use one prepared by suitably combining an organic solvent and an electrolyte. As the organic solvent, any solvent may be used so long as it is useful for batteries of this type. For example, it is possible to use propylene carbonate, ethylene carbonate, diethyl carbonate, dimethyl carbonate, 1,2-dimethoxyethane, 1,2-diethoxyethane, γ-butyrolacton diethyl ether, sulfolan, methyl sulfolan, acetonitrile, an acetic acid ester, a butylic acid ester, a propionic acid ester, etc. Particularly, from the viewpoint of the voltage stability, it is preferred to use a cyclic carbonate such as propylene carbonate, or a chain-structured carbonate such as dimethyl carbonate or diethyl carbonate. Further, such organic solvents may be used alone, or two or more of them may be used as mixed.

Further, as other non-aqueous electrolytes, it is possible to use a solid electrolyte containing an electrolyte salt, a polymer electrolyte, a solid or geled electrolyte having an electrolyte mixed or dissolved in e.g. a polymer compound, etc.

The solid electrolyte may be any material so long as it has lithium ion conductivity, and for example, either one of an inorganic solid electrolyte and a polymer electrolyte may be used.

As the inorganic solid electrolyte, it is possible to use lithium nitride, lithium iodide, etc.

As the polymer electrolyte, it is possible to use an electrolyte salt and a polymer compound which dissolves the electrolyte salt. And, as such a polymer compound, it is possible to use an ether type polymer such as poly(ethylene oxide) or a crosslinked product thereof, a poly(methacrylate) ester type polymer, an acrylate type polymer, etc. alone or as mixed or copolymerized.

The matrix for the geled electrolyte may be any one so long as it is geled upon absorption of the above non-aqueous electrolyte, and various polymers may be employed. Further, as the polymer material to be used for the geled electrolyte, it is possible to use, for example, a fluorinated polymer such as poly(vinylidene fluoride) or poly(vinylidene fluoride-hexafluoropropylene) copolymer. Further, as a polymer material to be used for the geled electrolyte, it is possible to use, for example, polyacrylonitrile or a copolymer of polyacrylonitrile. Further, as a polymer material to be used for the geled electrolyte, it is possible to use, for example, an ether type polymer, such as a polyethylene oxide, or a copolymer or cross-linked product of polyethylene oxide. The monomer for the copolymer may, for example, be polypropylene oxide, methyl methacrylate, butyl methacrylate, methyl acrylate or butyl acrylate.

Further, from the viewpoint of the stability against the redox reaction, it is particularly preferred to use a fluorinated polymer among the above-mentioned polymers.

As the electrolyte salt, any one of those commonly used for batteries of this type may be used. As such an electrolyte salt, for example, LiClO₄, LiPF₆, LiBF₄, CH₃SO₃Li, etc. may be used.

The shape of the lithium ion secondary battery of the present invention may be suitably selected depending on the intended use from e.g. a coin-shape, a sheet-form (film-form), a folded shape, a wound cylinder with bottom, a button shape, etc.

According to the method for producing a cathode active material for a lithium ion secondary battery of the present invention, it is possible to obtain a cathode active material for a lithium ion secondary battery which has a stable structure and the surface of which is covered with an electrochemically active Mn composite compound.

By constituting a cathode for a lithium ion secondary battery using the cathode active material, the cycle characteristics can be improved without decreasing the initial capacity of a lithium ion secondary battery, and further high durability can be realized.

### EXAMPLES

Now, the present invention will be described in further detail with reference to Examples. However, it should be understood that the present invention is by no means restricted to such specific Examples.

### <Synthesis of Lithium-Containing Composite Oxide>

By adding distilled water (1,245.9 g), nickel(II) sulfate hexahydrate (140.6 g), cobalt(II) sulfate heptahydrate (131.4 g) and manganese(II) sulfate pentahydrate (482.2 g) were uniformly dissolved to obtain raw material solution. By adding distilled water (320.8 g), ammonium sulfate (79.2 g) was uniformly dissolved to obtain an ammonia source solution. By adding distilled water (1,920.8 g), ammonium sulfate (79.2 g) was uniformly dissolved to obtain a mother liquid. By adding distilled water (600 g), sodium hydroxide (400 g) was uniformly dissolved to obtain a pH-adjusting liquid.

Into a 2 L baffle-equipped glass reactor, the mother liquid was put and heated to 50° C. by a mantle heater, and the pH-adjusting liquid was added to bring the pH to be 11.0. While stirring the solution in the reactor by anchor-type stirring vanes, the raw material solution was added at a rate of 5.0 g/min, and the ammonia source solution was added at a rate of 1.0 g/min, to have a composite hydroxide of nickel, cobalt and manganese precipitated. During the addition of the raw material solution, the pH-adjusting solution was added to maintain the pH in the reactor to be 11.0. Further, in order to prevent oxidation of the precipitated hydroxide, nitrogen gas was introduced into the reactor at a low rate of 0.5 L/min. Further, the liquid was continuously withdrawn so that the liquid amount in the reactor would not exceed 2 L.

In order to remove impurity ions from the obtained composite hydroxide of nickel, cobalt and manganese, pressure filtration and dispersion to distilled water were repeated for washing. The washing was terminated when the electrical conductivity of the filtrate became 25 μS/cm, followed by drying at 120° C. for 15 hours to obtain a precursor.

The contents of nickel, cobalt and manganese in the precursor were measured by ICP (inductively coupled plasma) and found to be 11.6 mass %, 10.5 mass % and 42.3 mass %, respectively, (nickel:cobalt:manganese=0.172:0.156:0.672 by molar ratio).

This precursor (20 g) and 12.6 g of lithium carbonate having a lithium content of 26.9 mol/kg were mixed and fired at 800° C. for 12 hours in an oxygen-containing atmosphere to obtain a lithium-containing composite oxide for Examples. The composition of the obtained lithium-containing composite oxide for Examples was Li_{1.2} (Ni_{0.172}Co_{0.156}Mn_{0.672})_{0.8}O₂. The lithium-containing composite oxide for Examples had an average particle size D50 of 5.3 μm, and a specific surface area of 4.4 m²/g as measured by means of BET (Brunauer, Emmett, Teller) method.

### Example 1

### Covering of Lithium-Containing Composite Oxide with Manganese

To 7.2 g of manganese acetate tetrahydrate (chemical formula: Mn(CH₃COO)₂.4H₂O, molecular weight: 245.09), 17.8 g of distilled water was added to prepare a Mn aqueous solution (composition (1)) having a pH of 7.0.

Then, to 15 g of the lithium-containing composite oxide for Examples under agitation, 3.6 g of the prepared Mn aqueous solution was added by spraying, and the lithium-containing composite oxide for Examples and the Mn aqueous solution were mixed and contacted. Then, the obtained mixture was heated in an oxygen-containing atmosphere at 600° C. for 3 hours to obtain a cathode active material in Example 1 comprising particles having an oxide containing Mn element locally distributed at the surface of the lithium-containing composite oxide.

The covering manganese formed by the Mn aqueous solution in the cathode active material is 0.03 by molar ratio (covering amount) to the total of nickel, cobalt and manganese being the transition metal elements in the lithium-containing composite oxide for Examples {(number of mols of covering Mn)/(total number of mols of Ni, Co and Mn of the lithium-containing composite oxide before addition)}.

Further, the cross-section of the obtained particles of the cathode active material was embedded with a resin and polished with fine particles of cerium oxide, followed by Mn mapping of the cross-section of the particles of the cathode active material by EPMA (X-ray microanalyzer), whereby a larger amount of Mn was detected at the outer surface of the particles than the inside of the particles.

### Examples 2 to 5

### Covering of Lithium-Containing Composite Oxide with Manganese

A cathode active material was obtained in the same manner as in Example 1 except that the conditions for covering the surface of the lithium-containing composite oxide with manganese were as identified in Table 1.

### Example 6

### Covering of Lithium-Containing Composite Oxide with Manganese and Nickel

A cathode active material was obtained in the same manner as in Example 1 except that the conditions for covering the surface of the lithium-containing composite oxide with the manganese compound were conditions of using a mixed solution of manganese acetate and nickel acetate as identified in Table 1. Here, {(total number of mols of covering Mn and Ni)/(total number of mols of Ni, Co and Mn in lithium-containing composite oxide before addition)}=0.03, and the molar ratio of covering Mn and Ni is Mn:Ni=75:25.

### Example 7

### Covering of Lithium-Containing Composite Oxide with Manganese, Nickel and Cobalt

A cathode active material was obtained in the same manner as in Example 1 except that the conditions for covering the surface of the lithium-containing composite oxide with the manganese compound were conditions of using a mixed solution of manganese acetate, nickel acetate and cobalt acetate as identified in Table 1. Here, {(total number of mols of covering Ni, Co and Mn)/(total number of mols of Ni, Co and Mn in lithium-containing composite oxide before addition)}=0.03, and the molar ratio of covering Mn, Ni and Co is Mn:Ni:Co=65:25:10.

### Example 8

### Covering of Lithium-Containing Composite Oxide with Manganese and Zirconium

The Mn solution of manganese acetate tetrahydrate was prepared in the same manner as in Example 1. Further, 22.82 g of distilled water was added to 2.18 g of an ammonium zirconium carbonate (chemical formula: (NH₄)₂[Zr(CO₃)₂(OH)₂]) aqueous solution having a zirconium content of 20.7 mass % as calculated as ZrO₂ to prepare a Zr aqueous solution having a pH of 6.0. Then, in the same manner as in Example 1 except that the Mn solution was sprayed and then the Zr solution was sprayed to the lithium-containing composite oxide, a cathode active material in Example 8 comprising particles having an oxide of Mn element and Zr element locally distributed at the surface of the lithium-containing composite oxide was obtained. Here, {(total number of mols of covering Mn and Zr)/(total number of mols of Ni, Co and Mn in lithium-containing composite oxide before addition)}=0.03, and the molar ratio of covering Mn and Zr is Mn:Zr=75:25.

### Example 9

### Covering of Lithium-Containing Composite Oxide with Manganese and Titanium

The Mn solution of manganese acetate tetrahydrate was prepared in the same manner as in Example 1, and a titanium lactate solution was prepared. Then, in the same manner as in Example 1 except that the Mn solution was sprayed and then the Ti solution was sprayed to the lithium-containing composite oxide, a cathode active material in Example 9 comprising particles having an oxide of Mn element and Ti element locally distributed at the surface of the lithium-containing composite oxide was obtained. Here, {(total number of mols of covering Mn and Ti)/(total number of mols of Ni, Co and Mn in lithium-containing composite oxide before addition)}=0.03, and the molar ratio of covering Mn and Ti is Mn:Ti=75:25.

### Example 10

### Covering of Lithium-Containing Composite Oxide with Manganese and Aluminum

The Mn solution of manganese acetate tetrahydrate was prepared in the same manner as in Example 1. Further, 22.80 g of distilled water was added to 2.20 g of a basic aluminum lactate aqueous solution having an aluminum content of 8.5 mass % as calculated as Al₂O₃ to prepare an Al aqueous solution having a pH of 5.5. Then, in the same manner as in Example 1 except that the Mn solution was sprayed and then the Al solution was sprayed to the lithium-containing composite oxide, a cathode active material in Example 10 comprising particles having an oxide of Mn element and Al element locally distributed at the surface of the lithium-containing composite oxide was obtained. Here, {(total number of cools of covering Mn and Al)/(total number of mols of Ni, Co and Mn in lithium-containing composite oxide before addition)}=0.03, and the molar ratio of covering Mn and Al is Mn:Al=75:25.

### Example 11

### Covering of Lithium-Containing Composite Oxide with Manganese

A cathode active material was obtained in the same manner as in Example 1 except that the conditions for covering the surface of the lithium-containing composite oxide with manganese were heat treatment conditions (400° C.) as identified in Table 1.

### Example 12

### Covering of Lithium-Containing Composite Oxide with Manganese and Nickel

A cathode active material was obtained in the same manner as in Example 6 except that the conditions for covering the surface of the lithium-containing composite oxide with manganese were conditions (with a heat treatment temperature of 400° C.) as identified in Table 1.

### Example 13

### Covering of Lithium-Containing Composite Oxide with Manganese and Zirconium

A cathode active material was obtained in the same manner as in Example 8 except that the conditions for covering the surface of the lithium-containing composite oxide with manganese were heat treatment conditions (400° C.) as identified in Table 1.

### Example 14

### Covering of Lithium-Containing Composite Oxide with Manganese

A cathode active material was obtained in the same manner as in Example 1 except that to cover the surface of the lithium-containing composite oxide with manganese, a manganese citrate aqueous solution having manganese carbonate dissolved in a citric acid solution was sprayed to the lithium-containing composite oxide, and that the conditions were as identified in Table 1.

### Example 15

### Covering of Lithium-Containing Composite Oxide with Manganese

A cathode active material was obtained in the same manner as in Example 1 except that to cover the surface of the lithium-containing composite oxide with manganese, a manganese maleate aqueous solution having manganese carbonate dissolved in a maleic acid solution was sprayed to the lithium-containing composite oxide, and that the conditions were as identified in Table 1.

### Example 16

### Covering of Lithium-Containing Composite Oxide with Manganese

A cathode active material is obtained in the same manner as in Example 1 except that to cover the surface of the lithium-containing composite oxide with manganese, a dispersion having manganese carbonate fine particles having an average particle size D50 of 50 nm dispersed in a solvent is used, this Mn dispersion is sprayed to the lithium-containing composite oxide, and the conditions are as identified in Table 1.

### Example 17

### Covering of Lithium-Containing Composite Oxide with Manganese

A cathode active material is obtained in the same manner as in Example 1 except that to cover the surface of the lithium-containing composite oxide with manganese, a dispersion having manganese hydroxide fine particles having an average particle size D50 of 50 nm dispersed in a solvent is used, this Mn dispersion is sprayed to the lithium-containing composite oxide, and the conditions are as identified in Table 1.

### Comparative Example 1

### No Covering

The lithium-containing composite oxide for Examples without covering treatment was taken as the cathode active material in Comparative Example 1.

### Comparative Example 2

### Covering of Lithium-Containing Composite Oxide with a Large Amount of Zirconium

11.9 g of distilled water was added to 13.1 g of an ammonium zirconium carbonate (chemical formula: (NH₄)₂[Zr(CO₃)₂(OH)₂]) aqueous solution having a zirconium content of 20.7 mass % as calculated as ZrO₂ to prepare a Zr aqueous solution having a pH of 6.0.

Then, to 15 g of the lithium-containing composite oxide for Examples under agitation, 3 g of the prepared Zr aqueous solution was added by spraying, and the lithium-containing composite oxide for Examples and the Zr aqueous solution were mixed and contacted. Then, the obtained mixture was dried at 90° C. for 3 hours and then heated at 500° C. for 5 hours in an oxygen-containing atmosphere to obtain a cathode active material of Comparative Example 2 comprising particles having an oxide of Zr element locally distributed at the surface of the lithium-containing composite oxide. Here, {(total number of mols of Zr)/(total number of mols of Ni, Co and Mn in lithium-containing composite oxide before addition)}=0.019.

### <Preparation of Cathode Sheet>

Using, as the cathode active material, cathode active materials (A) to (D) in Examples 1 to 17 and Comparative Examples 1 and 2, respectively, the cathode active material, acetylene black (electrically conductive material) and polyvinylidene fluoride solution (solvent: N-methylpyrrolidone) containing 12.1 mass % of polyvinylidene fluoride (binder), were mixed, and N-methylpyrrolidone was further added to prepare a slurry. The mass ratio of the cathode active material, acetylene black and the polyvinylidene fluoride was 80/12/8. The slurry was applied on one side of an aluminum foil (cathode current collector) having a thickness of 20 μm by means of a doctor blade, followed by drying at 120° C. and roll pressing twice to prepare a cathode sheet in each of Examples 1 to 17 and Comparative Examples 1 and 2, to be a cathode for a lithium battery.

### <Assembling of Battery>

A stainless steel simple sealed cell type lithium battery using each of the cathode active materials in Examples 1 to 17 and Comparative Examples 1 and 2 was assembled in an argon globe box by using as a cathode one punched out from the above-described cathode sheet in each of Examples 1 to 17 and Comparative Examples 1 and 2, as an anode a metal lithium foil having a thickness of 500 μm, as an anode current collector a stainless steel plate having a thickness of 1 mm, as a separator a porous polypropylene having a thickness of 25 μm and further as an electrolytic solution, LiPF₆ at a concentration of 1 (mol/dm³)/EC (ethylene carbonate)+DEC (diethyl carbonate) (1:1) solution (which means a mixed solution having LiPF₆ as a solute dissolved in EC and DEC in a volume ratio (EC:DEC=1:1).

### <Evaluation of Initial Capacity> <Evaluation of Cycle Characteristics>

With respect to the lithium batteries in Examples 1 to 17 and Comparative Examples 1 and 2 thus obtained, battery evaluation was carried out at 25° C.

The battery was charged to 4.8 V with a load current of 150 mA per 1 g of the cathode active material and then discharged to 2.5 V with a load current of 37.5 mA per 1 g of the cathode active material. The discharge capacity of the cathode active material from 4.8 to 2.5 V is taken as the initial capacity at 4.8 V. Then, the battery was charged to 4.3 V with a load current of 150 mA per 1 g of the cathode active material and then discharged to 2.5 V with a load current of 37.5 mA per 1 g of the cathode active material.

With respect to the lithium batteries using the cathode active materials in Examples 1 to 17 and Comparative Examples 1 and 2 after such charge/discharge was conducted, a charge/discharge cycle of charging to 4.5 V with a load current of 200 mA per 1 g of the charged/discharged cathode active material and then discharging to 2.5 V with a load current of 100 mA per 1 g of the cathode active material, was repeated 100 times. The discharge capacity in the first charge/discharge cycle at 4.5 V is taken as the initial capacity at 4.5 V. A value obtained by dividing the discharge capacity in the 100th charge/discharge cycle at 4.5 V by the discharge capacity in the first charge/discharge cycle at 4.5 V is taken as the cycle retention rate.

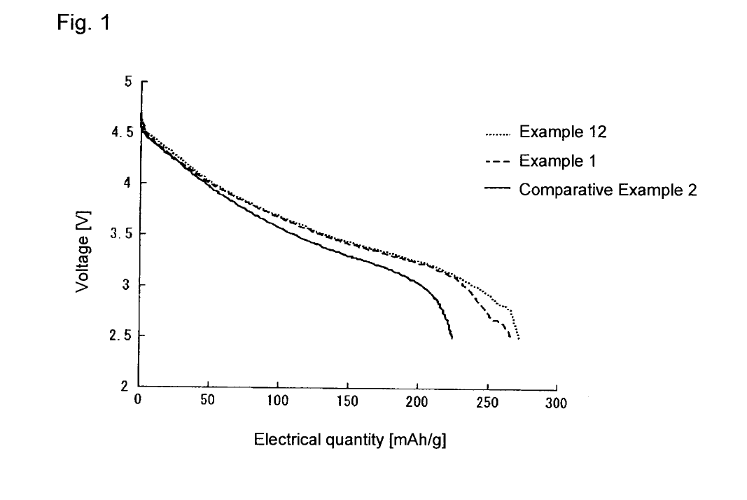

Of the lithium batteries using the cathode active materials in Examples 1 to 17 and Comparative Examples 1 and 2, the conditions for covering the surface of the lithium-containing composite oxide, the initial capacity at 4.8 V, the initial capacity at 4.5 V and the cycle retention rate are shown in Table 1. Further, discharge curves of the lithium batteries using the cathode active materials in Examples 1 and 12 and Comparative Example 2 are shown in FIG. 1.

TABLE 1

| | | | | | Initial | Initial | Capacity |
|---|---|---|---|---|---|---|---|
| | | | Heat | | capacity | capacity | retention |
| | | | treatment | Covering | at 4.8 V | at 4.5 V | rate in |
| | First metal compound | Second metal compound | temperature | amount | [mAh/g] | [mAh/g] | 100th cycle |
| Ex. 1 | Manganese acetate | Nil | 600° C. | 0.03 | 266 | 209 | 79% |
| Ex. 2 | Manganese acetate | Nil | 300° C. | 0.03 | 266 | 212 | 71% |
| Ex. 3 | Manganese acetate | Nil | 900° C. | 0.03 | 249 | 195 | 82% |
| Ex. 4 | Manganese acetate | Nil | 600° C. | 0.01 | 270 | 211 | 79% |
| Ex. 5 | Manganese acetate | Nil | 600° C. | 0.06 | 249 | 192 | 65% |
| Ex. 6 | Manganese acetate | Nickel acetate (25 mol %) | 600° C. | 0.03 | 265 | 211 | 77% |
| | (75 mol %) | | | | | | |
| Ex. 7 | Manganese acetate | Nickel acetate (25 mol %) + | 600° C. | 0.03 | 265 | 211 | 77% |
| | (65 mol %) | cobalt acetate (10 mol %) | | | | | |
| Ex. 8 | Manganese acetate | Ammonium zirconium carbonate | 600° C. | 0.03 | 264 | 210 | 80% |
| | (75 mol %) | (25 mol %) | | | | | |
| Ex. 9 | Manganese acetate | Titanium lactate (25 mol %) | 600° C. | 0.03 | 264 | 210 | 80% |
| | (75 mol %) | | | | | | |
| Ex. 10 | Manganese acetate | Basic aluminum lactate | 600° C. | 0.03 | 265 | 210 | 79% |
| | (75 mol %) | (25 mol %) | | | | | |
| Ex. 11 | Manganese acetate | Nil | 400° C. | 0.03 | 270 | 218 | 80% |
| Ex. 12 | Manganese acetate | Nickel acetate (25 mol %) | 400° C. | 0.03 | 272 | 219 | 82% |
| | (75 mol %) | | | | | | |
| Ex. 13 | Manganese acetate | Ammonium zirconium carbonate | 400° C. | 0.03 | 271 | 218 | 78% |
| | (75 mol %) | (25 mol %) | | | | | |
| Ex. 14 | Manganese citrate | Nil | 600° C. | 0.03 | 269 | 210 | 79% |
| Ex. 15 | Manganese maleate | Nil | 600° C. | 0.03 | 268 | 212 | 79% |
| Ex. 16 | Manganese carbonate | Nil | 500° C. | 0.03 | 269 | 210 | 80% |
| | fine particles | | | | | | |
| Ex. 17 | Manganese hydroxide | Nil | 500° C. | 0.03 | 268 | 209 | 81% |
| | fine particles | | | | | | |
| Comp | Nil | Nil | — | — | 264 | 209 | 27% |
| Ex. 1 | | | | | | | |
| Comp. | Ammonium zirconium | Nil | 500° C. | 0.019 | 225 | 176 | 83% |
| Ex. 2 | carbonate | | | | | | |

As shown in Table 1, with the lithium batteries using the cathode active materials in Examples 1 to 17, a high cycle retention rate was obtained as compared with the lithium battery using the cathode active material in Comparative Example 1. Further, in the discharge curves of the lithium batteries in Examples 1 and 12 as shown in FIG. 1, a peak at a low potential derived from oxidation/reduction of manganese was observed. Further, as shown in FIG. 1, in Example 12 in which the lithium-containing composite oxide was covered with Mn and Ni, substantially the same discharge curve as in Example 1 in which the lithium-containing composite oxide was covered with Mn alone, is obtained. Accordingly, it is evident that the heat treatment temperature is significantly influential in the increase of the capacity.

On the other hand, as shown in Table 1, with the lithium battery in Comparative Example 1 prepared by using a cathode formed by using a cathode active material prepared without covering the surface of the lithium-containing composite oxide, the cycle retention rate was so low as 27%. Further, as shown in FIG. 1, with the lithium battery in Comparative Example 1, the electrical quantity is low particularly at a low potential.

Further, in Comparative Example 2, the covering amount of ZrO₂ covering the surface of the lithium-containing composite oxide is so large as 0.019 by molar ratio to the total amount of nickel, cobalt and manganese contained in the lithium-containing composite oxide, and accordingly the discharge capacity was very low. Accordingly, it is evident that in a case where the surface of the lithium-containing composite oxide is covered with a compound containing Zr element, the larger the covering amount, the more the capacity is decreased.

It is evident from the results in Examples 1 to 17 and Comparative Examples 1 and 2 that when a cathode is prepared by using a cathode active material for a lithium ion secondary battery obtained by the production method of the present invention, and a lithium ion secondary battery is constituted using the cathode, excellent discharge capacity and cycle characteristics are obtained and in addition, high durability is obtained.

### INDUSTRIAL APPLICABILITY

According to the present invention, it is possible to obtain a cathode active material for a lithium ion secondary battery, having a high discharge capacity per unit mass and being excellent in cycle characteristics. This cathode active material is useful for lithium ion secondary batteries for electronic instruments such as cell phones, and for vehicles, which are small in size and light in weight.

This application is a continuation of PCT Application No. PCT/JP2012/053004, filed on Feb. 9, 2012, which is based upon and claims the benefit of priority from Japanese Patent Application No. 2011-026273 filed on Feb. 9, 2011. The contents of those applications are incorporated herein by reference in its entirety.

What is claimed is:

1. A method for producing a cathode active material for a lithium ion secondary battery, which comprises contacting the following composition (1) with a lithium-containing composite oxide comprising Li element and at least one transition metal element selected from the group consisting of Ni, Co and Mn (provided that the molar amount of the Li element is more than 1.2 times the total molar amount of said transition metal element), followed by heating:
composition (1): a composition having a compound (1) containing no Li element and comprising Mn element as an essential component, dissolved or dispersed in a solvent.

2. The method for producing a cathode active material for a lithium ion secondary battery according to claim 1, wherein the composition (1) further contains a compound (2) containing Ni element and/or Zr element.

3. The method for producing a cathode active material for a lithium ion secondary battery according to claim 1, wherein the heating is carried out at from 350 to 800° C.

4. The method for producing a cathode active material for a lithium ion secondary battery according to claim 1, wherein the amount of the metal element contained in the compound (1) is within a range of from 0.002 to 0.05% by molar ratio to the amount of the transition metal element contained in the lithium-containing composite oxide.

5. The method for producing a cathode active material for a lithium ion secondary battery according to claim 1, wherein the proportion of the following Mn composite oxide contained in the cathode active material is such an amount, as the metal element amount in the Mn composite oxide, of from 0.001 to 0.10 molar times the molar amount of the transition metal element in the lithium-containing composite oxide:
Mn composite oxide: a composite oxide comprising Mn as an essential component, formed by reaction of the lithium-containing composite oxide and the composition (1).

6. The method for producing a cathode active material for a lithium ion secondary battery according to claim 1, wherein the solvent in the composition (1) is water.

7. The method for producing a cathode active material for a lithium ion secondary battery according to claim 1, wherein pH of the composition (1) is within a range of from 3 to 12.

8. The method for producing a cathode active material for a lithium ion secondary battery according to claim 1, wherein said contacting of the composition (1) with the lithium-containing composite oxide is carried out by adding the composition (1) to the lithium-containing composite oxide under agitation and mixing the composition (1) and the lithium-containing composite oxide.

9. The method for producing a cathode active material for a lithium ion secondary battery according to claim 1, wherein said contacting of the composition (1) with the lithium-containing composite oxide is carried out by spraying the composition (1) to the lithium-containing composite oxide by a spray coating method.

10. The method for producing a cathode active material for a lithium ion secondary battery according to claim 1, wherein the lithium-containing composite oxide is a compound represented by the following formula (3):
Li(LiₓMn_{y}Me_{z})OₚF_{q} (3)
wherein Me is at least one element selected from the group consisting of Co, Ni, Cr, Fe, Al, Ti, Zr, Mo, Nb, V and Mg, 0.09<x<0.3, y>0, z>0, 0.4≦y/(y+z)≦0.8, x+y+z=1, 1.2<(1+x)/(y+z), 1.9<p<2.1, and 0≦q≦0.1.

11. The method for producing a cathode active material for a lithium ion secondary battery according to claim 10, wherein Me is Co and Ni.

12. A method for producing a cathode for a lithium ion secondary battery, which comprises producing a cathode active material for a lithium ion secondary battery by the production method as defined in claim 1, and forming a cathode active material layer containing the cathode active material for a lithium ion secondary battery, an electrically conductive material and a binder on a cathode current collector.

13. A method for producing a lithium ion secondary battery, which comprises producing a cathode for a lithium ion secondary battery by the production method as defined in claim 12, and constituting a lithium ion secondary battery using the cathode, an anode and a non-aqueous electrolyte.
